(19) United States
(12) Patent Application Publication
(10) Pub. No.: US 2007/0131113 A1
(43) Pub. Date: Jun. 14, 2007

(54) Transporting apparatus

(76) Inventors: Todd Christian Gadbury, Batavia, OH (US); Douglas Edward Royer, Bethel, OH (US)

Correspondence Address: Todd C. Gadbury, 4309 Southcross Drive, Batavia, OH, 45103, US

(21) Appl. No.: 11/636,935

(22) Filed: Dec. 11, 2006

Related U.S. Application Data
(60) Provisional application No. 60/749,110, filed on Dec. 12, 2005.

(51) Int. Cl. B01D 46/00

(52) U.S. Cl. 95/273

(57) ABSTRACT

Methods and devices for transporting, cleaning or storing materials such as alternative fuels like shelled corn or wood pellets. Material is transferred to a first container through a transfer conduit as a result of negative pressure created by a vacuum. Small, lighter impurities such as corn dust, red-eyes, bees-wings and the like are removed from the material by the vacuum as the material enters the first container. The material then passes from the first container to a second container. The material is then transferred through the second container by way of a paddlewheel which is driven by a motor. As the material exits the second container it passes through a screen which prevents large, heavier impurities such as stones, husks and the like from passing. The cleaned material then enters either a storage container or a holding compartment where it can be stored or consumed as fuel.

This application claims priority to Provisional Patent Application No. 60/749,110 filed Dec. 12, 2005 which is expressly incorporated herein in its entirety by reference thereto.

### FIELD OF THE INVENTION

The present invention relates generally to an apparatus and method for the cleaning, transporting or storing a material. More particularly, the present invention relates to an apparatus for cleaning, transporting or storing granular materials such as alternative fuels such as shelled corn and wood pellets.

### BACKGROUND INFORMATION

The cost of conventional fuels such as coal, fuel oil, natural gas and propane continues to escalate. Many of these fuels will eventually cease to exist altogether. As a result, alternative fuels such as shelled corn and wood pellets and the like are becoming increasingly more attractive as an energy source. These alternative fuels are readily renewable because they can be grown in sufficient quantities to meet increasing demands.

There are increasing numbers of uses for alternative fuels in the market today. For example, alternative fuels are currently being used as a fuel source in ovens, furnaces, stoves and boilers in both residential and commercial markets. Users of these fuels currently suffer from several major drawbacks. First, most users do not have a means with which to handle large volumes of the fuel source in an efficient, cost effective manner. As a result, users typically must purchase small individually packaged bags of fuel at high costs. The ability to purchase large quantities of fuel would dramatically reduce the cost of operating an alternative fuel device.

Second, alternative fuels such as shelled corn and wood pellets and the like are preferably cleaned before they are consumed. Cleaning may include removing broken kernels or pellets and impurities such as corn dust, red-eyes, bees-wings, cob pieces, husks, stalks and stones. Reducing the amount of impurities in the fuel increases performance and reduces the amount of ash output thereby improving air quality. Thus, there is believed to be a need for an apparatus which transports, cleans and/or stores alternative fuels such as shelled corn and wood pellets.

### SUMMARY

According to an example embodiment of the present invention, a transporting apparatus includes: a first container having an input opening, a vacuum means and an output opening and a second container having an input opening in mechanical communication with the output opening of the first container such that the two containers are air-tight. Negative pressure created by the vacuum means causes a material to enter the first container through the input opening, exit the first container through the output opening of the first container thereby entering the second container. The second container may include an output opening.

The input opening of the first container may be in mechanical communication with a transfer conduit such that material passes through the transfer conduit and enters the first container through the input opening.

The first container may include a filter positioned between the input opening and the vacuum means such that material does not pass through the filter before exiting the first container through the output opening.

The vacuum means may be in mechanical communication with a transfer conduit.

The second container may include a transferring means for transferring material through the second container. The transferring means may be a paddlewheel. The paddlewheel preferably maintains an air-tight seal with the first container and may be driven by a motor.

The second container may include a screen in communication with the output opening of the second container wherein material passes through the screen as it exits the second container

According to another example embodiment of the present invention, an apparatus for transporting material includes: a first container having an input opening, a vacuum means and an output opening wherein negative pressure created by the vacuum means causes material to enter the first container through the input opening and a transferring means located within the first container for transferring material through the first container from the input opening to the output opening.

The first container may include a filter positioned between the input opening and the vacuum means such that material does not pass through the filter before exiting through the output opening.

The first container may include a screen in communication with the output opening wherein material passes through the screen as it exits the first container.

The input opening of the first container may be in mechanical communication with a transfer conduit such that material passes through the transfer conduit and enters the first container through the input opening.

The vacuum means may be in mechanical communication with a transfer conduit.

The transferring means may be a screw driven by a motor wherein the screw is rotatable about an axis parallel to the output opening such that material is transferred from the input opening to the output opening by the screw.

An apparatus for transporting material may further include a second container having an input opening in mechanical communication with the output opening of the first container to form an air tight connection. Negative pressure created by the vacuum means causes material to enter the first container through the input opening, exit the first container through the output opening thereby entering the second container. The second container may include an output opening.

According to another example embodiment of the present invention, a system for transporting, storing and cleaning a material includes: a transfer conduit, a first container having an input opening in communication with the transfer conduit, a vacuum means and an output opening and a second container having an input opening in air-tight communication with the output opening of the first container wherein negative pressure created by the vacuum means causes material to enter the first container through the input opening via the transfer conduit, exit the first container through the output opening thereby entering the second container.

According to another example embodiment of the present invention, a method of transporting and cleaning a material, includes: transporting material from a source to a first container through a transfer conduit by means of negative pressure created by a vacuum means; removing impurities from the material with the vacuum means as the material enters the first container and passes to a second container; transferring the material with a transferring means through the second container while maintaining an air-tight seal; and passing the material through a screen as the material exits the second container.

Example embodiments of the present invention are described in more detail below with reference to the appended Figures.

### BRIEF DESCRIPTION OF THE DRAWINGS

FIG. 1 is a perspective view of an apparatus for transporting material.

FIG. 2 is a perspective view of an apparatus for transporting material.

FIG. 3 is a perspective view of an apparatus for transporting and storing material.

FIG. 4a is a perspective view of an apparatus for transporting material.

FIG. 4b is a perspective view of an apparatus for transporting material.

FIG. 5 is a diagram of a system for transporting material.

FIG. 6 is a diagram of a system for transporting material.

### DETAILED DESCRIPTION

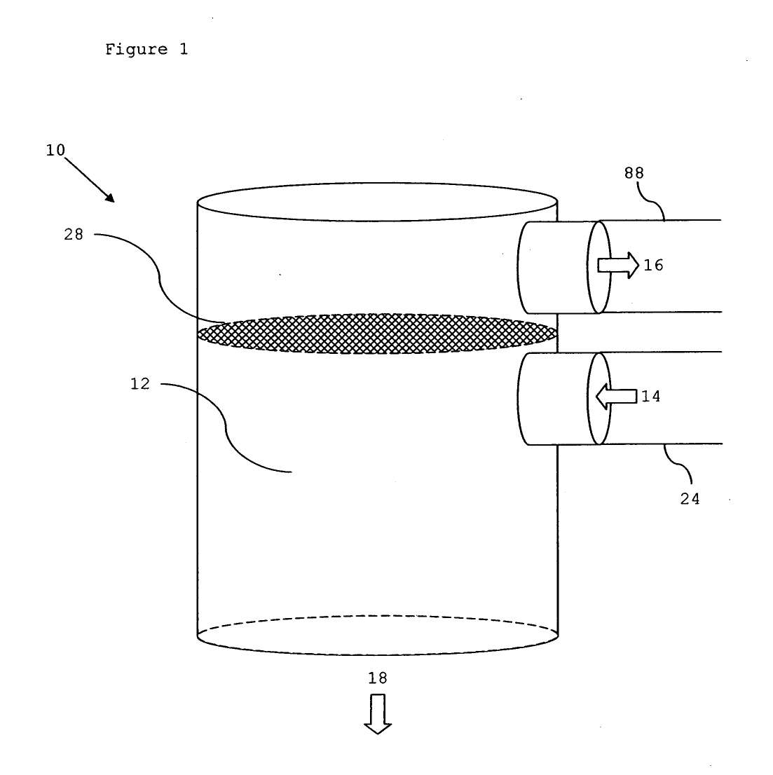

FIG. 1 illustrates a transporting apparatus 10 for transporting a material. Transporting apparatus 10 includes a first container 12 having an input opening 14, a vacuum means 16 and an output opening 18. Negative pressure created by the vacuum means 16 causes material (not shown) to enter first container 12 through input opening 14. Lighter impurities such as corn dust, red-eyes, bees-wings and the like are removed from the material by the vacuum means as the material passes through first container 12. The material then exits first container 12 through output opening 18.

First container 12 is illustrated as cylindrical in shape in FIG. 1. However, first container 12 may be any size, shape or configuration. First container 12 need not be a uniform shape i.e. the bottom portion of first container 12 may taper in the area of output opening 18. In the absence of an air-tight seal within first container 12 it is preferable to use a tapered arrangement in the area of output opening 18 in order to maintain sufficient negative pressure to transport material.

Vacuum means 16 may be any means or arrangement capable of creating sufficient negative pressure to cause material to enter first container 12. For example, standard wet/dry vacuums, household vacuum cleaners and the like provide sufficient negative pressure to cause material to enter first container 12. Negative pressure created by the vacuum means 16 also facilitates removal of lighter impurities from the material as the material passes through the first container 12.

First container 12 includes a filter 28 located between input opening 14 and vacuum means 16 to facilitate removal of smaller, lighter impurities from the material.

Input opening 14 is in communication with a transfer conduit 24. Transfer conduit 24 may be a hose, pipe or any conduit capable of transporting material from a source to the input opening 14. Alternatively, a transfer conduit may not be used and material may be placed directly into input opening 14. Vacuum means 16 may also be in communication with a transfer conduit 88. Transfer conduit 88 may be a hose, pipe or any conduit capable of maintaining sufficient negative pressure necessary to transport material from a source through the input opening 14. Transfer conduit 88 preferably facilitates removal of small, lighter impurities contained in the material. Alternatively, a transfer conduit may not be used and vacuum means 16 may be in direct communication with first container 12.

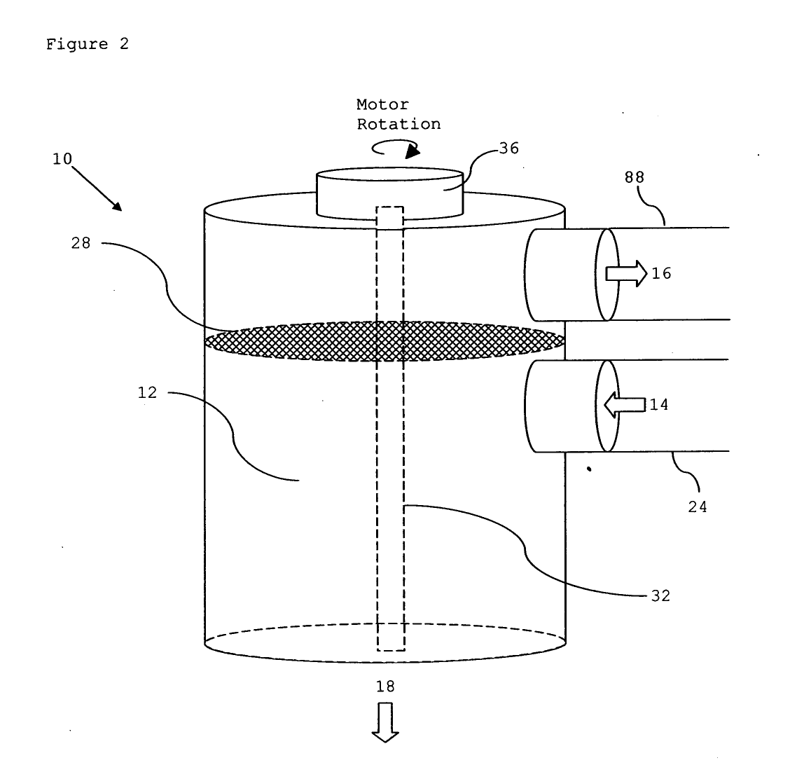

As shown in FIG. 2, transporting apparatus 10 may include a transferring means for transferring material from input opening 14 to output opening 18. The transferring means may be any device capable of transferring material through the container. For example, the transferring means may be a screw 32 rotatable about an axis parallel to output opening 18 such that material is transferred through first container 12 when screw 32 is rotated in a continuous fashion. Screw 32 may be driven by a motor 36.

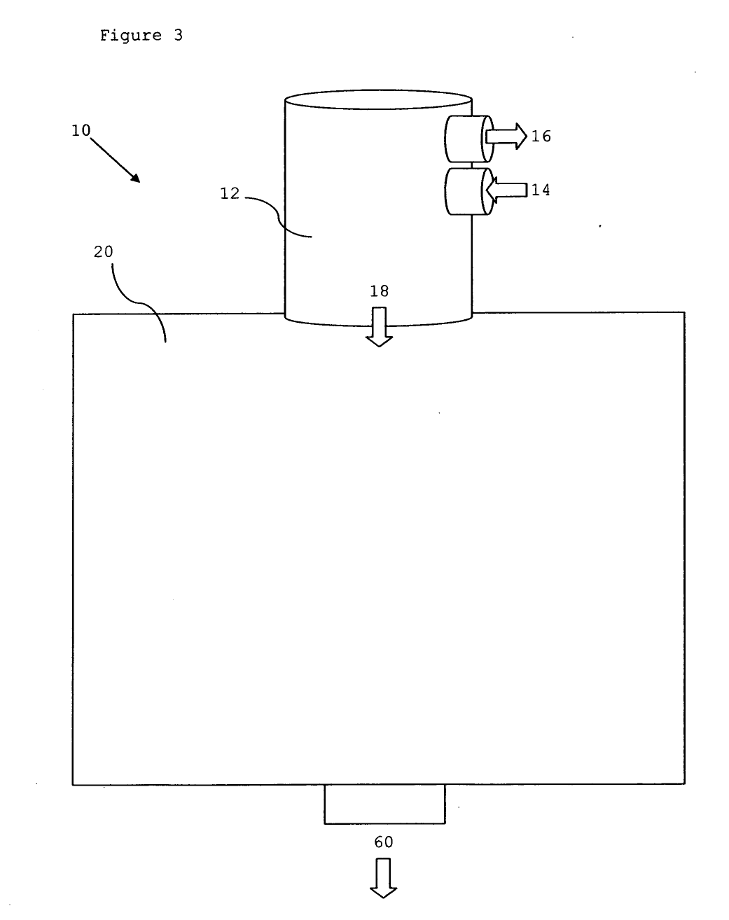

As illustrated in FIG. 3, transporting apparatus 10 further includes a second container 20 having an input opening cooperatively arranged with an output opening 18 of first container 12 such that material may pass from first container 12 to second container 20. Second container 20 may include an output opening 60. Output opening 60 facilitates removal or further transportation of material.

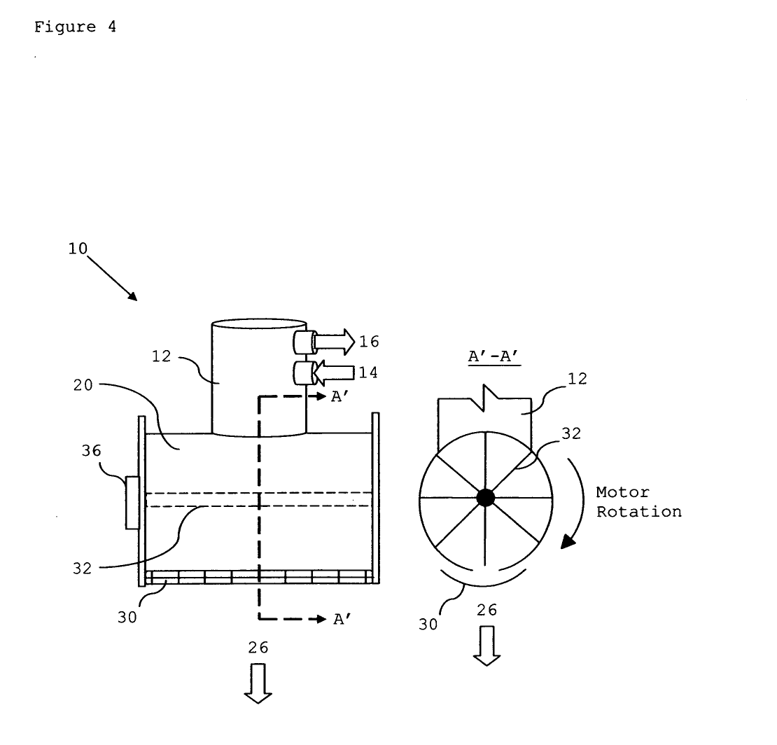

FIG. 4 illustrates a transporting apparatus 10. Transporting apparatus 10 includes a first container 12 having an input opening 14, a vacuum means 16 and an output opening 18. Transporting apparatus 10 may also include a second container 20 having an input opening in mechanical communication with output opening 18 of first container 12. Negative pressure created by vacuum means 16 causes material to enter first container 12 through input opening 14. The material exits first container 12 through output opening 18 thereby entering second container 20.

Input opening 14 may be in communication with a transfer conduit 24 as shown in FIG. 2. Transfer conduit 24 may be a hose, pipe or any conduit capable of transporting material from a source to the input opening 14. Vacuum means 16 may also be in communication with a transfer conduit 88 as shown in FIG. 2. Transfer conduit 88 may be a hose, pipe or any conduit capable of maintaining sufficient negative pressure necessary to transport material from a source through the input opening 14. Transfer conduit 88 preferably facilitates removal of small, lighter impurities contained in the material.

First container 12 may include a filter 28 (as shown in FIG. 2) located between input opening 14 and vacuum means 16 for removing small light-weight impurities from the material.

Second container 20 of transporting apparatus 10 may include an output opening 26 permitting material to pass. Second container 20 includes a screen 30 adapted to prevent impurities from passing through second container 20 while permitting the material to pass. Screen 30 may be made of any material and of any arrangement so long as the material may pass while large heavy-weight impurities may not.

Second container 20 may include a transferring means (not shown) for transferring material through the container to output opening 26. Transferring means preferably maintains an airtight seal within second container 20. Transferring means may be a device capable of transferring material thru second container while preferably maintaining an air-tight seal.

As shown in FIG. 4, the transferring means is a paddlewheel 32 rotatable about an axis perpendicular to output opening 26 wherein paddlewheel 32 transfers material from through the container to output opening 26. Paddlewheel 32 is rotated by a motor 36.

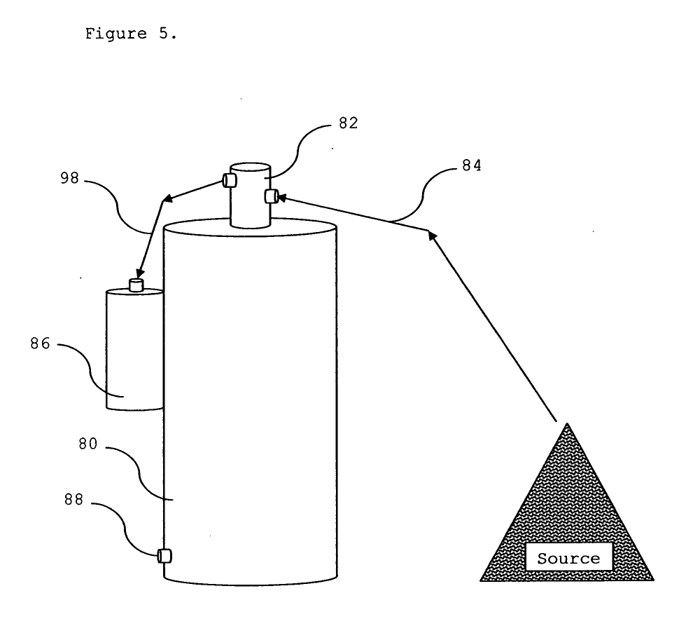

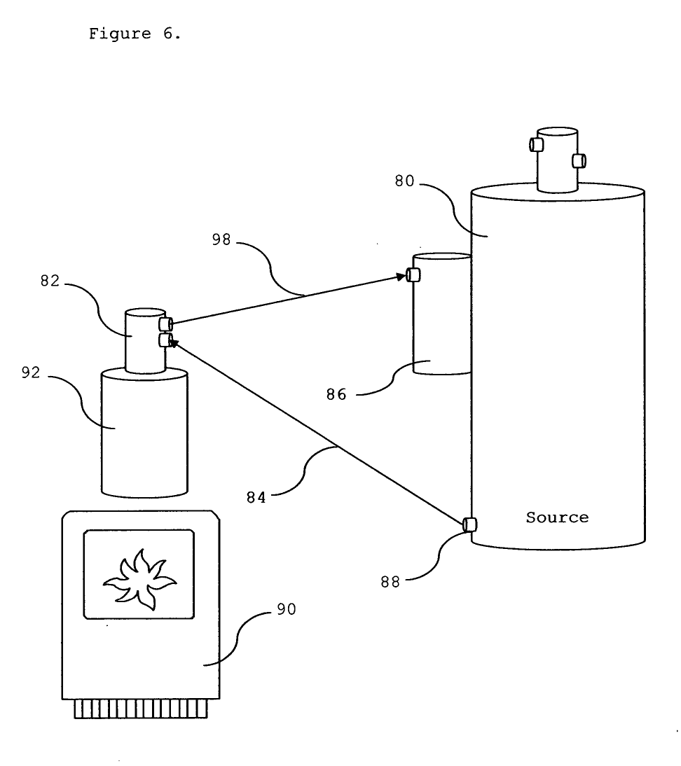

FIG. 5 illustrates a transporting system for transporting bulk quantities of material to a bulk storage container 80. Negative pressure created by vacuum means 86 causes material to be transferred from a bulk source to first container 82 via transfer conduit 84. As the material enters first container 82 smaller, lighter impurities are removed from the material by the vacuum means 86. Material then enters bulk storage container 80 where it can be stored. Bulk storage container 80 includes an output opening 88 for removing the material. Material may be removed from bulk storage container 80 through output opening 88 using gravity or by connecting the transporting apparatus described above or as illustrated in FIG. 6.

FIG. 6 illustrates a transporting system for transporting material from a bulk source to a compartment or a consumption source such as a stove, furnace or oven. In this system, material is transferred from a bulk container 80. Negative pressure created by vacuum means 86 causes material to enter cleaning compartment 82 through transfer conduit 84. Small, light impurities are removed from the material by vacuum means 86 as the material passes through cleaning container 82. Material then enters compartment 92 to be stored or consumed by consumption source 90. Compartment 92 may be separate or integral with consumption source 90. Material can be transferred directly to consumption source 90 through cleaning compartment 82.

The method of transporting, cleaning or storing material includes the steps of transporting material from a source to a first container through a transfer conduit by means of negative pressure created by a vacuum means. Removing impurities from the material with the vacuum means as the material enters the first container and passes to a second container. Transferring the material with a transferring means through the second container while maintaining an air-tight seal. Passing the material through a screen as the material exits the second container.

What is claimed is:

1. A transporting apparatus, comprising:
a first container having an input opening, a vacuum means and an output opening;
a second container having an input opening in mechanical communication with the output opening of the first container wherein the two containers are air-tight such that negative pressure created by the vacuum means causes a material to enter the first container through the input opening, exit the first container through the output opening of the first container thereby entering the second container.

2. The apparatus according to claim 1, wherein the input opening of the first container is in mechanical communication with a transfer conduit such that material passes through the transfer conduit and enters the first container through the input opening.

3. The apparatus according to claim 1, wherein a filter is positioned between the input opening of the first container and the vacuum means such that material does not pass through the filter before exiting the first container through the output opening.

4. The apparatus according to claim 1, wherein the vacuum means is in mechanical communication with a transfer conduit.

5. The apparatus according to claim 1, wherein the second container includes an output opening.

6. The apparatus according to claim 5, wherein the second container includes a transferring means for transferring material through the second container.

7. The apparatus according to claim 6, wherein the transferring means is a paddlewheel.

8. The apparatus according to claim 7, wherein the paddlewheel maintains an air-tight seal with the first container.

9. The apparatus according to claim 8, wherein the paddlewheel is driven by a motor.

10. The apparatus according to claim 5, further including a screen in communication with the output opening of the second container wherein material passes through the screen as it exits the second container

11. An apparatus for transporting a material, comprising:
a first container having an input opening, a vacuum means and an output opening wherein negative pressure created by the vacuum means causes material to enter the first container through the input opening;
a transferring means located within the first container for transferring material through the first container from the input opening to the output opening.

12. The apparatus according to claim 11, wherein the first container includes a filter positioned between the input opening and the vacuum means such that material does not pass through the filter before exiting through the output opening.

13. The apparatus according to claim 11, wherein the first container includes a screen in communication with the output opening wherein material passes through the screen as it exits the first container.

14. The apparatus according to claim 11, wherein the input opening of the first container is in mechanical communication with a transfer conduit such that material passes through the transfer conduit and enters the first container through the input opening.

15. The apparatus according to claim 11, wherein the vacuum means is in mechanical communication with a transfer conduit.

16. The apparatus according to claim 11, wherein the transferring means is a screw driven by a motor wherein the screw is rotatable about an axis parallel to the output opening such that material is transferred from the input opening to the output opening by the screw.

17. The apparatus according to claim 11, further comprising a second container having an input opening in mechanical communication with the output opening of the first container to form an air tight connection wherein negative pressure created by the vacuum means causes material to enter the first container through the input opening, exit the first container through the output opening thereby entering the second container.

18. The apparatus according to claim 17, wherein the second container includes an output opening.

19. A system for transporting, storing and cleaning a material, comprising:
a transfer conduit;
a first container having an input opening in communication with the transfer conduit, a vacuum means and an output opening;
a second container having an input opening in air-tight communication with the output opening of the first container wherein negative pressure created by the vacuum means causes material to enter the first container through the input opening via the transfer conduit, exit the first container through the output opening thereby entering the second container.

20. A method of transporting and cleaning a material, comprising:
transporting material from a source to a first container through a transfer conduit by means of negative pressure created by a vacuum means;
removing impurities from the material with the vacuum means as the material enters the first container and passes to a second container;
transferring the material with a transferring means through the second container while maintaining an air-tight seal; and
passing the material through a screen as the material exits the second container.
